(19) United States
(12) Patent Application Publication
(10) Pub. No.: US 2008/0109536 A1
(43) Pub. Date: May 8, 2008

(54) METHOD OF FORMING CLUSTER INDIVIDUALLY BY EACH SENSOR NODE OVER SENSOR NETWORK

(75) Inventors: Seung-Ki HONG, Daejeon-city (KR); Yeon Jun Choi, Daejeon-city (KR); Sun-Joong Kim, Daejeon-city (KR); Cheol Sig Pyo, Daejeon-city (KR); Jong-Suk Chae, Daejeon-city (KR)

Correspondence Address: RABIN & Berdo, PC, 1101 14TH STREET, NW, SUITE 500, WASHINGTON, DC, 20005, US

(73) Assignee: ELECTORONICS & TELECOMMUNICATIONS RESEARCH INSTITUTE, Daejeon (KR)

(21) Appl. No.: 11/929,913

(22) Filed: Oct. 30, 2007

(30) Foreign Application Priority Data
Nov. 8, 2006 (KR) 10-2006-0110167

(51) Int. Cl. G06F 15/16

(52) U.S. Cl. 709/220

(57) ABSTRACT

Provided is method of forming a cluster individually by each sensor node over a sensor network, in which each sensor node has cluster information and authority to assign cluster membership and recognizes a sensor node that is not a cluster member in a radius of the cluster in order to include the recognized sensor node in the cluster as a cluster member. The sensor node that becomes a member of the cluster wirelessly receives an application of the cluster in order to be upgraded. Thus, after initial sensor node setting, a cluster can be formed automatically and a program suitable for each cluster can be upgraded without human intervention.

### CROSS-REFERENCE TO RELATED PATENT APPLICATION

This application claims the benefit of Korean Patent Application No. 10-2006-0110167, filed on Nov. 8, 2006, in the Korean Intellectual Property Office, the disclosure of which is incorporated herein in its entirety by reference.

### BACKGROUND OF THE INVENTION

1. Field of the Invention

The present invention generally relates to a method of forming a cluster individually by each sensor node over a sensor network, and more particularly, to a method of forming a cluster individually by each sensor node over a sensor network, in which each sensor node has information on the cluster and authority to assign cluster membership and recognizes a sensor node that is not a cluster member in a radius of the cluster in order to include the recognized sensor node in the cluster as a cluster member, and an application is transmitted to each of the sensor nodes of the cluster in order to upgrade the each of the sensor nodes.

2. Description of the Related Art

Due to the inherent nature of a sensor network, sensor nodes over the sensor network operate for a long period of time without any artificial access or battery replacement once they start operating. It is necessary to perform a wireless upgrade for each of the sensor nodes without the artificial access.

In other words, the sensor nodes over the sensor network have to support various types of services or applications according to applied services or applications and change according to their physical peripheral conditions. Services or applications are provided to a user via a cluster of sensor nodes over a network instead of via a single sensor node. A cluster means a group of sensor nodes for providing a service or achieving an objective. In order to meet the requirements of sensor nodes and provide services or applications via a cluster, multiple independent cluster-based applications have to be managed by the sensor nodes, and when any sensor node is included in a cluster as a cluster member during execution, an execution program for the cluster has to be dynamically received and installed.

For a program upgrade in a conventional MATE virtual machine, a system can use multiple independent cluster-based applications composed of virtual machine based byte codes on sensor nodes. Thus, if a sensor node is included in at least one cluster, it carries out its duty as a member of the cluster and performs a necessary program upgrade. However, when the sensor node joins the cluster, a problem occurs in security and a limitation emerges in terms of supporting an application service.

Moreover, there is a limitation in initially defining or forming a cluster of sensor nodes because the states or conditions, such as positions, of the sensor nodes may change during operations.

### SUMMARY OF THE INVENTION

The present invention provides a method of forming a cluster individually by each sensor node over a sensor network, in which each sensor node individually recognizes new sensor nodes, checks if the new sensor nodes satisfy cluster member conditions, and assigns cluster authority if they satisfy the cluster member conditions, and performs an upgrade process for cluster activities by means of transmission of a program, and thus each member sensor node of a cluster knows the existence of the cluster and has information necessary for the formation of the cluster.

According to one aspect of the present invention, there is provided a method of forming a cluster individually by each sensor node over a sensor network. The method includes recognizing a second sensor node as a new sensor node based on cluster radius information including position information, wherein the recognizing is performed by a first sensor node that is a member of a cluster formed for service providing and application over the sensor network, determining whether the second sensor node can be a member of the cluster based on at least one of setting information of the cluster, sensor information of the second sensor node, a hardware state of the second sensor node, and information owned by the second sensor node, when the recognized second sensor node is not a member of the cluster, wherein the determining is performed by the first sensor node, and transmitting an authentication indication indicating that the second sensor node is a member of the cluster to the second sensor node if the first sensor node determines that the second sensor node can be a member of the cluster, wherein the transmitting is performed by the first sensor node.

### BRIEF DESCRIPTION OF THE DRAWINGS

The above and other features and advantages of the present invention will become more apparent by describing in detail exemplary embodiments thereof with reference to the attached drawings in which:

FIG. 1 is a conceptual diagram illustrating the structure of a sensor node according to an exemplary embodiment of the present invention;

FIG. 2 is a conceptual diagram illustrating cluster member sensor nodes in a cluster radius and a non cluster member sensor node outside the cluster radius according to an exemplary embodiment of the present invention;

FIG. 3 is a conceptual diagram illustrating cluster member sensor nodes that recognize a non cluster member sensor node in a cluster radius according to an exemplary embodiment of the present invention;

FIG. 4 is a flowchart illustrating a processing procedure when a cluster member sensor node discovers a new sensor node according to an exemplary embodiment of the present invention;

FIG. 5 is a flowchart illustrating a process of determining whether a discovered new sensor node can join a cluster as a cluster member according to an exemplary embodiment of the present invention;

FIG. 6 is a flowchart illustrating a processing procedure when a new non cluster member sensor node is located in a cluster radius according to an exemplary embodiment of the present invention;

FIG. 7 is a ladder diagram of messages transmitted and received between a cluster member sensor node and a non cluster member sensor node that satisfies an authority key condition according to an exemplary embodiment of the present invention;

FIG. 8 is a ladder diagram of messages transmitted and received between a cluster member sensor node and a non cluster member sensor node that fails to satisfy an authority key condition, including a node information inquiry message, according to an exemplary embodiment of the present invention; and

FIG. 9 is a ladder diagram of messages transmitted and received between a cluster member sensor node and a non cluster member sensor node that finally fails to obtain cluster membership according to an exemplary embodiment of the present invention.

### DETAILED DESCRIPTION OF THE INVENTION

Hereinafter, exemplary embodiments of the present invention will be described in detail with reference to the accompanying drawings. It should be noted that like reference numerals refer to like elements illustrated in one or more of the drawings. In the following description of the present invention, detailed descriptions of known functions and configurations incorporated herein will be omitted for conciseness and clarity.

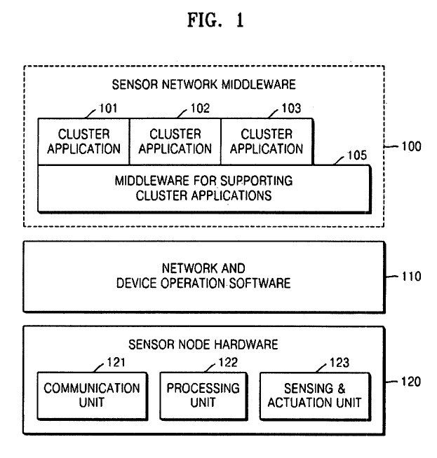

FIG. 1 is a conceptual diagram illustrating the structure of a sensor node according to an exemplary embodiment of the present invention.

In other words, FIG. 1 illustrates hardware, middleware, and software constituting the sensor node. Referring to FIG. 1, the sensor node includes sensor node hardware 120 as a hardware layer, and the sensor node hardware 120 includes a communication unit 121 in charge of communications with other sensor nodes, a processing unit 122, and a sensing/actuation unit 123 for sensing-related processing.

Network and device operation software 110 is interposed between the sensor node hardware 120 and sensor network middleware 100, and the sensor network middleware 100 includes middleware for supporting cluster applications 105 and independent cluster-based applications 101, 102, and 103. Hereinafter, ‘cluster-based application’ and ‘cluster application’ mean the same.

The present invention suggests the sensor network middleware 100 capable of independently driving multiple cluster applications. The present invention also includes a wireless upgrade for the cluster-based applications 101, 102, and 103 operating in sensor nodes. Each of the sensor nodes can dynamically assign cluster membership, thereby providing wireless data exchange in relation to the upgrade for the cluster-based applications 101, 102, and 103.

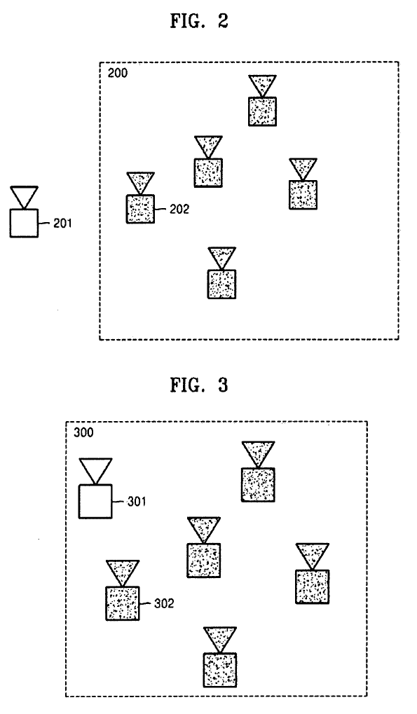

FIG. 2 is a conceptual diagram illustrating cluster member sensor nodes 202 in a cluster radius (or the radius of a cluster) 200 and a non cluster member sensor node 201 outside the cluster radius 200 according to an exemplary embodiment of the present invention.

A cluster indicates a group of sensor nodes that are formed to provide a service to a user or are formed for an application. The cluster is initially formed by user or system setting and includes at least one sensor node. Each of the at least one sensor node first receives information regarding cluster formation. The received information includes the spatial or temporal range of the cluster, information regarding an authority key, i.e., a key that can be authenticated using cluster formation conditions, such as a particular identifier (ID), an indication for authenticating a member, such as cluster membership, or the like.

Referring to FIG. 2, the cluster member sensor nodes 202 present in the cluster radius 200 and the non cluster member sensor node 201 outside the cluster radius 200 are distinguished. When a new node enters the cluster radius 200, the cluster member sensor nodes 202 can recognize the entrance of the new node.

FIG. 3 is a conceptual diagram illustrating cluster member sensor nodes that recognize a non cluster member sensor node 301 in a cluster radius 300 according to an exemplary embodiment of the present invention.

The cluster radius 300 does not mean only the spatial range of a cluster. The cluster formation conditions are determined based on a temporal factor as well as a physical position. For example, a cluster may be formed on condition that the cluster is activated only from 9 AM to 9 PM. Thus, a cluster of sensor nodes is formed within a corresponding temporal range and a corresponding spatial range. However, a sensor node can be a cluster member in consideration of several factors as well as the temporal and spatial factors. In FIG. 3, when the non cluster member sensor node 301 moves into the cluster radius 300, a cluster member sensor node 302 recognizes such a movement of the non cluster member sensor node 301.

Each of sensor nodes of a cluster has an authority key that is a particular distinguished value for authenticating the sensor node as a cluster member. The authority key can be authenticated by ID information of a particular sensor node, hardware authentication information, or other individual information. Similar to a real-life situation where a certain service is provided only to a VIP member, membership assignment according to an authority key is performed by inquiring of a candidate sensor node whether it has an authority key and assigning cluster membership to the candidate sensor node if the candidate sensor node has an authority key. If the candidate sensor node satisfies necessary conditions in order to be allowed to be a cluster member when a cluster member inquires of the candidate sensor node information on the candidate sensor node, even though the candidate sensor node has no authority key, the cluster member can assign cluster membership to the candidate sensor node. The inquired node information includes the remaining battery capacity in terms of hardware, available memory status, type of sensing performed by a corresponding sensor node, information contained in a corresponding sensor node, and the like.

A sensor node assigned cluster membership by an inquiry-response result stands by while preparing to download and install a corresponding cluster program. A cluster member sensor node that stores the cluster program then transmits the cluster program to the sensor node that is standing by.

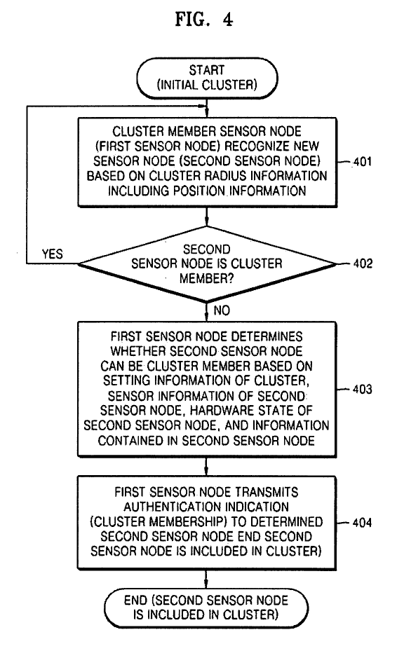

FIG. 4 is a flowchart illustrating a processing procedure when a cluster member sensor node discovers a new sensor node according to an exemplary embodiment of the present invention.

FIG. 4 shows how each node can form a cluster after initial cluster formation. Referring to FIG. 4, a cluster member sensor node, which will hereinafter be referred to as a first sensor node, of a cluster recognizes a new sensor node, which will hereinafter be referred to as a second sensor node, based on cluster radius information including position information in operation 401. Such a recognition process involves the first sensor node discovering the second sensor node during another operation of the first sensor node. For example, the first sensor node may discover the second sensor node in the course of transmitting and receiving messages to and from the new node.

If the recognized second sensor node is a member node of the cluster in operation 402, no consideration is required because it is not a new node. However, if not a member node of the cluster, the first sensor node having recognized the second sensor node determines whether the second sensor node can be a member of the cluster in consideration of setting information of the cluster, sensor information of the second sensor node, the hardware state of the second sensor node, information owned by the second sensor node, and the like, in operation 403.

For the determination of the first sensor node, if the recognized second sensor node is not a member node of the cluster, the first sensor node first inquires of the second sensor node whether the second sensor node is a preset node of the cluster.

If the second sensor node is not a preset node of the cluster, the first sensor node then inquires of the second sensor node in order to determine whether the second sensor node can be a member of the cluster based on at least one of the setting information of the cluster, the sensor information of the second sensor node, the hardware state of the second sensor node, and the information owned by the second sensor node.

If the first sensor node determines that the second sensor node can be a member of the cluster, the first sensor node transmits a cluster authentication indication corresponding to cluster membership to the second sensor node in operation 404.

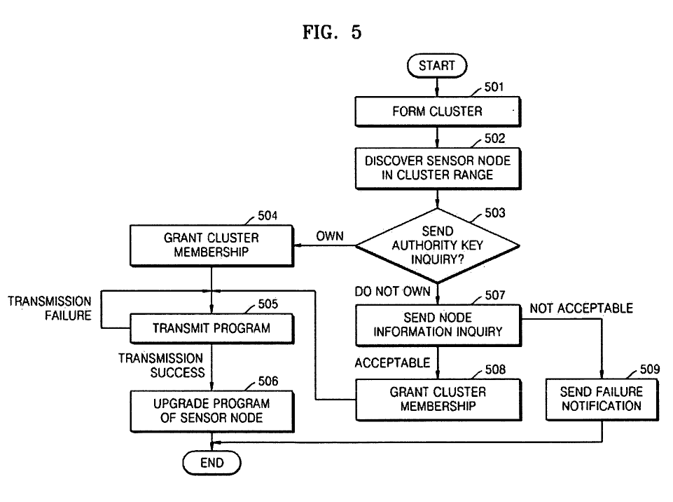

FIG. 5 is a flowchart illustrating a process of determining whether a discovered new sensor node can be a cluster member according to an exemplary embodiment of the present invention.

In the process illustrated in FIG. 5, if a new sensor node is discovered in a cluster operation 502 after the cluster is formed in operation 501, an existing cluster member determines whether to include the discovered sensor node in the cluster as a cluster member. To this end, the existing cluster member sends an authority key inquiry to request an authority key that the discovered sensor node previously owned in operation 503, determines whether the discovered sensor node can be a member of the cluster based on the received authority key and, if so, grants cluster membership to the discovered sensor node in operation 504, transmits a cluster program in operation 505, and upgrades a program of the discovered sensor node in operation 506.

If the discovered sensor node fails to satisfy an authority key condition, i.e., it owns no authority key or its authority key fails to satisfy a corresponding condition in operation 503, the existing cluster member sends a node information inquiry to request information of the discovered sensor node in operation 507 in order to check suitability as a cluster member. If the discovered sensor node passes the suitability check, the existing cluster member grants cluster membership to the discovered sensor node in operation 508, transmits the cluster program in operation 505, and upgrades the cluster program of the discovered sensor node in operation 506. However, if the discovered sensor node fails to pass the suitability check, the existing cluster member sends a failure notification, indicating that the discovered sensor node fails to pass the suitability check and thus cannot be a member of the cluster, to the discovered sensor node in operation 509.

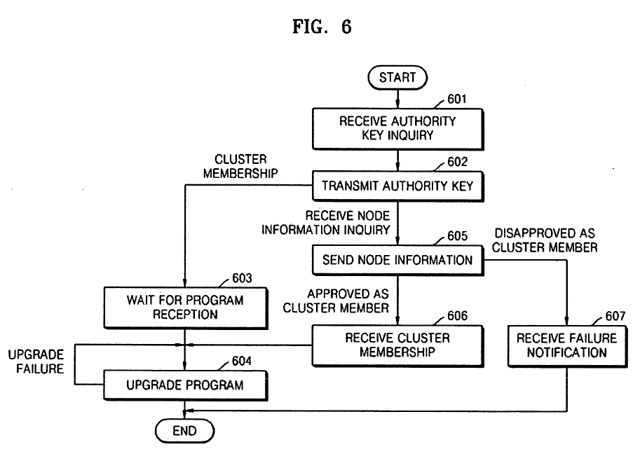

FIG. 6 is a flowchart illustrating a processing procedure when a new non cluster member sensor node is located in a cluster radius according to an exemplary embodiment of the present invention.

The processing procedure illustrated in FIG. 6 involves processing inquiries and the like in association with whether or not a non cluster member sensor node, i.e., a second sensor node, which spatially and temporally enters the radius of a formed cluster, can be a member of the cluster. This procedure corresponds to the determination of whether to include the second sensor node in the cluster in FIG. 5 in view of the second sensor node. The second sensor node first receives an authority key inquiry in operation 601 and sends its authority key to a cluster member sensor node, i.e., a first sensor node, in operation 602.

If the second sensor node satisfies the authority key condition, the second sensor node receives cluster membership and also receives a program in operation 603. The second sensor node upgrades its program using the received program in operation 604.

If the second sensor node fails to satisfy the authority key condition, the second sensor node receives a node information inquiry and sends its node information to the first sensor node in operation 605. If the first sensor node determines that the second sensor node can be a cluster member as a result of a suitability check, the second sensor node receives cluster membership in operation 606. If the first sensor node determines that the second sensor node cannot be a cluster member, the second sensor node receives a failure notification indicating that the second sensor node fails to pass the suitability check and thus cannot be a cluster member in operation 607.

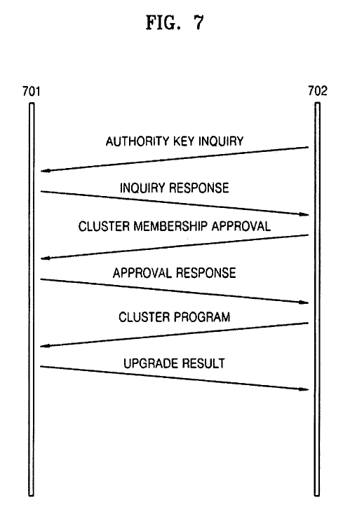

FIG. 7 is a ladder diagram of messages transmitted and received between a cluster member sensor node 702 and a non cluster member sensor node 701 that satisfies an authority key according to an exemplary embodiment of the present invention.

The messages illustrated in FIG. 7 are exchanged between a non cluster member sensor node and a cluster member sensor node during a cluster program upgrade process when the non cluster member sensor node satisfies the authority key condition for joining a formed cluster. In brief, in FIG. 7, the cluster member sensor node 702 sends an authority key inquiry to the non cluster member sensor node 701 and transmits cluster membership and an upgrade program to the non cluster member sensor node 701 if an inquiry response is acceptable.

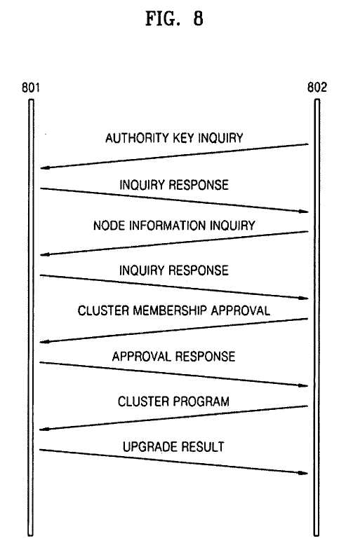

FIG. 8 is a ladder diagram of messages transmitted and received between a cluster member sensor node 802 and a non cluster member sensor node 801 that fails to satisfy the authority key condition, including a node information inquiry message, according to an exemplary embodiment of the present invention.

The messages illustrated in FIG. 8 are exchanged between the non cluster member sensor node 801 and the cluster member sensor node 802 when the non cluster member sensor node 801 fails to satisfy an authority key condition for joining a formed cluster, and thus receives a node information inquiry from the cluster member sensor node 802, sends an inquiry response, obtains cluster membership, and upgrades its program with a cluster program.

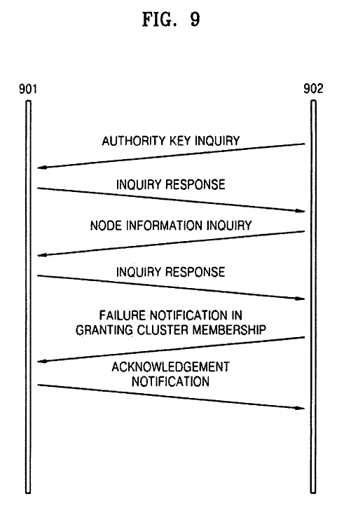

FIG. 9 is a ladder diagram of messages transmitted and received between a cluster member sensor node 902 and a non cluster member sensor node 901 that finally fails to obtain cluster membership according to an exemplary embodiment of the present invention.

The messages illustrated in FIG. 9 are exchanged between the cluster member sensor node 902 and the non cluster member sensor node 901 when the non cluster member sensor node 901 fails to satisfy an authority key condition for joining a formed cluster, and thus receives a node information inquiry from the cluster member sensor node 902, sends an inquiry response, but fails to obtain cluster membership from the cluster member sensor node 902 because the inquiry response is not acceptable, and thus cannot upgrade its program with a cluster program.

Meanwhile, the embodiment of the present invention can be written as computer programs and can be implemented in general-use digital computers that execute the programs using a computer readable recording medium. Examples of the computer readable recording medium include magnetic storage media (e.g., ROM, floppy disks, hard disks, etc.), optical recording media (e.g., CD-ROMs, or DVDs), and storage media such as carrier waves (e.g., transmission through the Internet). The computer readable recording medium can also be distributed over network coupled computer systems so that the computer readable code is stored and executed in a distributed fashion.

As described above, according to the present invention, after initially setting or forming cluster, for providing a particular service, each node of the cluster includes a new node in the cluster as a cluster member node based on information of the cluster, thereby efficiently and automatically forming the cluster with necessary nodes according to peripheral conditions and states of the nodes without any human intervention. Moreover, the nodes of the cluster can be automatically upgraded with cluster-based applications.

While the present invention has been particularly shown and described with reference to an exemplary embodiment thereof, it will be understood by those of ordinary skill in the art that various changes in form and detail may be made therein without departing from the spirit and scope of the present invention as defined by the following claims.

What is claimed is:

1. A method of forming a cluster individually by each sensor node over a sensor network, the method comprising:
(a) recognizing a second sensor node as a new sensor node based on cluster radius information including position information, wherein the recognizing is performed by a first sensor node that is a member of a cluster formed for service providing and application over the sensor network;
(b) determining whether the second sensor node can be a member of the cluster based on at least one of setting information of the cluster, sensor information of the second sensor node, a hardware state of the second sensor node, and information owned by the second sensor node, when the recognized second sensor node is not a member of the cluster, wherein the determining is performed by the first sensor node; and
(c) transmitting an authentication indication indicating that the second sensor node is a member of the cluster to the second sensor node if the first sensor node determines that the second sensor node can be a member of the cluster, wherein the transmitting is performed by the first sensor node.

2. The method of claim 1, wherein (b) comprises:
(b-1) sending an inquiry to the second sensor node in order to check if the second sensor node is a preset node of the cluster when the recognized second sensor node is not a member of the cluster, wherein the sending is performed by the first sensor node; and
(b-2) sending an inquiry to the second sensor node in order to check if the second sensor node can be a member of the cluster based on at least one of the setting information of the cluster, the sensor information of the second sensor node, the hardware state of the second sensor node, and the information owned by the second sensor node, if the first sensor node determines that the second sensor node is not a preset node of the cluster, wherein the sending is performed by the first sensor node, and
wherein (c) comprises transmitting an authentication indication indicating that the second sensor node is a member of the cluster to the second sensor node if the first sensor node determines that the second sensor node is the preset node of the cluster or can be a member of the cluster, wherein the transmitting is performed by the first sensor node.

3. The method of claim 2, wherein in (b-1), the checking if the second sensor node is the preset node of the cluster is performed by checking if identification (ID) information of the second sensor node or individual information of the second sensor node corresponds to an authority key with respect to the cluster.

4. The method of claim 1, wherein in (a), the cluster formed for service providing and application includes at least one sensor node when the cluster is initially formed and each of the at least one sensor node includes information on the cluster and an authentication indication indicating the each sensor node is a member of the cluster.

5. The method of claim 1, wherein in (c), after the first sensor node transmits the authentication indication to the second sensor node, the first sensor node transmits an application program of the cluster to the second sensor node in order to upgrade a program of the second sensor node.

6. A computer-readable recording medium having recorded thereon a program for executing the method claimed in claim 5.

7. A computer-readable recording medium having recorded thereon a program for executing the method claimed in claim 4.

8. A computer-readable recording medium having recorded thereon a program for executing the method claimed in claim 3.

9. A computer-readable recording medium having recorded thereon a program for executing the method claimed in claim 2.

10. A computer-readable recording medium having recorded thereon a program for executing the method claimed in claim 1.
